(19) United States
(12) Patent Application Publication
(10) Pub. No.: US 2026/0195145 A1
(43) Pub. Date: Jul. 9, 2026

(54) SYSTEMS AND METHODS FOR GRAPH INTERPRETATION USING GENERATIVE ARTIFICIAL INTELLIGENCE

(71) Applicant: Wells Fargo Bank, N.A., San Francisco, CA (US)

(72) Inventors: Thomas E. Bell, San Francisco, CA (US); Chao Chen, San Francisco, CA (US); Omar Bryan Khan, Richmond, VA (US); Carleton Jay Lindgren, San Francisco, CA (US); Winthrop Treynor Smith, San Francisco, CA (US)

(73) Assignee: Wells Fargo Bank, N.A., San Francisco, CA (US)

(21) Appl. No.: 19/011,558

(22) Filed: Jan. 6, 2025

(51) Int. Cl. G06F 9/451

(52) U.S. Cl. CPC G06F 9/451

(57) ABSTRACT

Systems and methods for improving graphical user interfaces and data interpretation are provided. A method may include determining, using a generative artificial intelligence (GAI) model, an ontology defining a plurality of interconnected nodes of a dataset, generating at least one textual element and one or more visual elements corresponding with the interconnected nodes, providing the at least one textual element and the one or more visual elements to a graphical user interface (GUI), receiving, via the GUI, a selection corresponding with the at least one textual element or the one or more visual elements, and updating, via the GUI, at least one of the at least one textual element or the one or more visual elements based on the selection. Updating the textual element may cause the visual element to update, and updating the visual element may cause the textual element to update.

### TECHNICAL FIELD

The present disclosure relates to systems and methods for improving graphical user interfaces and data interpretation. More particularly, the aspects and embodiments of the present disclosure relate to processing and displaying complex graphical data.

### BACKGROUND

Users and systems may face technical challenges when interacting with large datasets, particularly when large datasets are presented as complex graphs, such as graphs having numerous nodes and connections. The numerous connections and nodes of these complex graphs may obscure relationships between specific nodes or groups of nodes and cause challenges for users or systems in interpreting data represented by the graphs. For example, users may need to navigate between multiple graphical user interfaces (GUIs) to view and analyze data represented in the complex graphs, which places an elevated demand on system resources caused by users continuously interacting with the GUI(s). Further, the increased demand on system resources may cause delays or other inefficiencies when users or systems attempt to modify the depicted complex graphs. Thus, there is a desire for improved systems and methods that facilitate more efficient interpretation of complex graphs and provide improved user interfaces that reduce system resource usage.

### SUMMARY

One embodiment relates to a method. The method may include determining, by one or more processing circuits using a generative artificial intelligence (GAI) model, an ontology defining a plurality of interconnected nodes of a dataset. The method may include generating, by the one or more processing circuits, at least one textual element and one or more visual elements corresponding with the plurality of interconnected nodes. The method may include providing, by the one or more processing circuits, the at least one textual element and the one or more visual elements to a graphical user interface (GUI). The method may include receiving, by the one or more processing circuits and via the GUI, a selection corresponding with the at least one textual element or the one or more visual elements. The method may include updating, by the one or more processing circuits and via the GUI, at least one of the at least one textual element or the one or more visual elements based on the selection, wherein updating the at least one textual element causes the one or more visual elements to update, and wherein updating the one or more visual elements causes the at least one textual element to update.

Another embodiment relates to a system for interpreting complex data. The system includes one or more processing circuits including one or more processors coupled to one or more memory devices. The one or more processing circuits may be configured to determine, using a generative artificial intelligence (GAI) model, an ontology defining a plurality of interconnected nodes of a dataset. The one or more processing circuits may be configured to generate at least one textual element and one or more visual elements corresponding with the plurality of interconnected nodes. The one or more processing circuits may be configured to provide the at least one textual element and the one or more visual elements to a graphical user interface (GUI). The one or more processing circuits may be configured to receive, via the GUI, a selection corresponding with the at least one textual element or the one or more visual elements. The one or more processing circuits may be configured to update, via the GUI, at least one of the at least one textual element or the one or more visual elements based on the selection, wherein updating the at least one textual element causes the one or more visual elements to update, and wherein updating the one or more visual elements causes the at least one textual element to update.

Still another embodiment relates to a non-transitory computer-readable medium comprising instructions stored therein that, when executed by one or more processors, cause the one or more processors to perform operations. The operations may include determining, using a generative artificial intelligence (GAI) model, an ontology including a plurality of interconnected nodes of a dataset. The operations may include generating at least one textual element and one or more visual elements corresponding with the plurality of interconnected nodes. The operations may include providing the at least one textual element and the one or more visual elements to a graphical user interface (GUI). The operations may include receiving, via the GUI, a selection corresponding with the at least one textual element or the one or more visual elements. The operations may include updating, via the GUI, at least one of the at least one textual element or the one or more visual elements based on the selection, wherein updating the at least one textual element causes the one or more visual elements to update, and wherein updating the one or more visual elements causes the at least one textual element to update.

Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the embodiments may be combined with one or more features of a different aspect of the embodiments. Moreover, additional features may be recognized in certain embodiments and/or implementations that may not be present in all embodiments or implementations.

### BRIEF DESCRIPTION OF THE FIGURES

Various objects, aspects, features, and advantages of the disclosure will become more apparent and better understood by referring to the detailed description taken in conjunction with the accompanying drawings, in which like reference numbers and characters identify corresponding elements throughout. In the drawings, like reference numbers indicate identical, functionally similar, and/or structurally similar elements.

FIG. 1 is a block diagram depicting an example of a computing environment for analyzing complex graphical data, according to some arrangements.

FIG. 2 is a flowchart for a method of analyzing complex graphical data, according to some arrangements.

FIGS. 3A-3B depict an illustrative dynamic graphical user interface (GUI) updated between multiple states, according to some arrangements.

FIG. 4 is an embodiment of an illustrative graphical user interface (GUI) for analyzing complex graphical data, according to some arrangements.

FIG. 5 is an embodiment of an illustrative graphical user interface (GUI) for analyzing complex graphical data, according to some arrangements.

FIG. 6 depicts an illustrative three-dimensional environment for analyzing complex graphical data, according to some arrangements.

It will be recognized that some or all the Figures are schematic representations for purposes of illustration. The Figures are provided for the purpose of illustrating one or more embodiments with the explicit understanding that the Figures will not be used to limit the scope or the meaning of the claims.

### DETAILED DESCRIPTION

Referring to the Figures, the systems, methods, and computer-readable media disclosed herein relate to analyzing and interpreting complex graphical data using generative artificial intelligence (GAI). A current technical problem includes analyzing large datasets and, particularly, large datasets that may be represented as complex graphs. The complex graphs may be displayed on graphical user interfaces (GUIs) with numerous interconnected nodes, and the relationships or links between the nodes may become obscured as the complexity of the graph increases. For example, hairball graphs may include numerous nodes and connections between the nodes that collectively form a dense, tangled structure, which may be difficult to interpret, process, and/or comprehend. That is, users or systems may fail to accurately identify relationships between various nodes of a complex graph due to the volume of data or connections represented in such graphs. Further, GUIs used to present complex graphs to a user for interpretation may fail to provide sufficient data, information, or visual elements to aid the user in interpreting the complex graphs, such as identifying relationships between nodes.

In addition, users may be required to adjust or navigate between various views or GUIs (e.g., zooming in or out, opening multiple web pages or interfaces, etc.) to visualize and ultimately interpret or analyze these complex graphs. These repeated user interactions with system resources may increase processing power or resource load by, for example, causing rendering and continuously updating of the GUIs. Moreover, inefficiencies or increased resource demands may cause various delays in processing, updating, and/or outputting data. For example, due to increased resource load and slower processing times caused by complex graph visualization and manipulation, GUIs may fail to update and may further display outdated visual representations of complex graphs, which may delay data extraction or relationship identification. In addition, for devices with limited processing power and memory, such as mobile devices, such inefficiencies or increases in resource load may degrade performance and cause increased battery consumption. This may result in the screen “freezing,” whereby users cannot interact with their device, which may lead to frustration. Further, computational load, inefficiencies, and/or delays may increase as the complex graphs increase in size and/or complexity. These inefficiencies may degrade a user experience by causing slower performance (e.g., longer loading times), quicker battery drain, or other disruptions between components of data processing systems.

The systems, methods, and computer-readable media disclosed herein provide various technical advantages by addressing at least the aforementioned technical challenges associated with processing, interpreting, describing, and/or visualizing complex graphical data structures, such as hairball graphs. For example, one or more generative artificial intelligence (GAI) models may be implemented to dynamically identify, cluster, and output an ontology defining relationships between nodes of a complex graph, which may decrease a demand for manual input typically used to define such relationships, and may further identify connections or relationships that would be difficult or impossible for a user to visually identify. Additionally, intelligent filtering and clustering mechanisms may be implemented to identify or group related nodes or otherwise to adjust the presentation of complex datasets in response to user interactions, which may improve various data visualization or interpretation functions. In turn, the disclosed systems, methods, and computer-readable media provide efficient and responsive updates to complex data structures or corresponding visualizations of such structures without delays caused by manual intervention. For example, when processing a high-volume dataset with frequent updates, the graph structure and node relationships may be dynamically updated by the GAI model in response to changes in the dataset without manual redefinition of the connections. This reduces the need for multiple GUIs to depict various elements of the complex graphs, which reduces memory occupancy and enables quicker processing times. Accordingly, the disclosed systems, methods, and computer-readable media provide an improved data processing system or architecture configured to analyze large, complex graphs while optimizing data comprehension and responsiveness for users.

Additionally, the disclosed systems, methods, and computer-readable media provide an improve graphical user interface in analyzing or displaying complex graphical data. For example, by consolidating various different visualizations associated with a complex graph dataset into a single graphical user interface, the disclosed systems, methods, and computer-readable media reduce the processing power and memory required to interact with or interpret complex datasets which may otherwise require the generation and use of multiple GUIs. Beneficially, providing a single, dynamic graphical user interface reduces computational strain caused by loading and re-rendering multiple layers of complex graphs simultaneously, thereby decreasing overall resource usage of data processing systems. In addition, providing a single interface may streamline the presentation of complex graphs and reduce redundant data processing operations, further contributing to lower memory consumption on data processing systems. As described herein, reduced resource load or processing power may improve device performance, facilitate faster interactions updates to data, or preserve battery life. Furthermore, by consolidating complex graphical data within a single, dynamic graphical user interface, the disclosed systems, methods, and computer-readable media reduces processing delays and facilitate more efficient user interactions or updates to data, reduce overall resource consumption, and/or improve device performance in analyzing or interpreting complex graphs.

As described herein, the systems, methods, and computer-readable media relate to analyzing or interpreting complex graphical data. One embodiment of the present disclosure may relate to a method that includes determining, using a generative artificial intelligence (GAI) model, an ontology defining multiple interconnected nodes of a dataset. The method may further include generating textual elements (e.g., descriptions, labels, etc.) and visual elements (e.g., graphs, visualizations of related notes, etc.) corresponding with the interconnected nodes, and providing the textual elements and visual elements to a GUI. The method may further include receiving, via the GUI, a selection (e.g., user input) corresponding with the textual elements or the visual elements. Based on the selection, the method may further include updating, via the GUI, at least one of the textual elements or visual elements. The visual elements and textual elements may be dynamically linked via the GUI such that updating the textual elements causes the visual elements to update, and updating the visual elements causes the textual elements to update.

As an example of operation, a provider computing system associated with a provider may receive material (e.g., documents, notes, verbal notes, etc.) regarding one or a plurality of topics, such as compliance-related information. The compliance-related information may include regulations, laws, industry standards, best practices, contractual obligations, audit findings, risk assessments, and/or internal policies associated with various jurisdictions or organizations. This compliance-related information is often voluminous and difficult to comprehend. Typically, a manual process is used to group similar topics within this information to identify relationships and controls (e.g., processes used to ensure or attempt to ensure) compliance with the received information and corresponding regulations, standards, and/or obligations. As described herein, the provider computing system may utilize one or more artificial intelligence models, and particular a generative artificial intelligence model(s), to provide, identify, and/or otherwise determine an ontology regarding the received compliance-related information. The ontology may define the relationships between the information received. In another embodiment, the ontology may be received by the provider computing system. The provider computing system may utilize the ontology to generate a graphical user interface, which may be provided via a user device (e.g., a smart phone). The graphical user interface may depict the received and/or determined ontology in a first portion, a first textual description regarding the ontology in a second portion of the graphical user interface, and a second textual description regarding the ontology in a third portion of the graphical user interface different from the portion. In one embodiment, the depicted ontology is represented as a graph, and particularly a hairball graph. The first textual description is a summary of the graph, and the second textual description is a table regarding features of the hairball graph. The summary of the graph may be generated by one or more generative AI models and, as such, represent a natural language description of the graph (or portions thereof). The table may, in contrast, represent information associated with the graph, such as listed laws, when the data for the data was received, when the laws were updated, and so on. That way, a user may receive a quick summary via the first portion and more concrete information via the second portion. In operation, when a selection is made in one of the three portions, the other portions update. For example, the user may select one or more nodes of the hairball graph. The underlying information associated with the nodes may be received and provided to the table depiction. Further, the underlying information may be provided as a prompt to the one or more generative AI models as a prompt to generate the summary. The same dynamic operation may occur via the user selecting any of the other portions of the GUI, which then responsively cause the other portions to update. Beneficially, the dynamic updating of the portions of the GUI based on a user selection may reduce the number of user interfaces needed to view various data. This may reduce the number of graphical user interfaces needed, and improve overall system operation. These and other features and benefits are described more fully herein below.

It should be understood that while the present disclosure is explained mainly in regard to interpreting complex graphs such as hairball graphs, such a description is not meant to be limiting. The principles described herein may be applicable to various types of data structures, and all such variations are intended to fall within the scope of the present disclosure.

As used herein, visual elements may refer to graphics, images, and/or illustrations displayed via a graphical user interface, such as a visualization of a complex graph with multiple nodes and corresponding connections (in the case of a hairball graph). As used herein, textual elements may refer to written or character-based descriptions displayed via a graphical user interface.

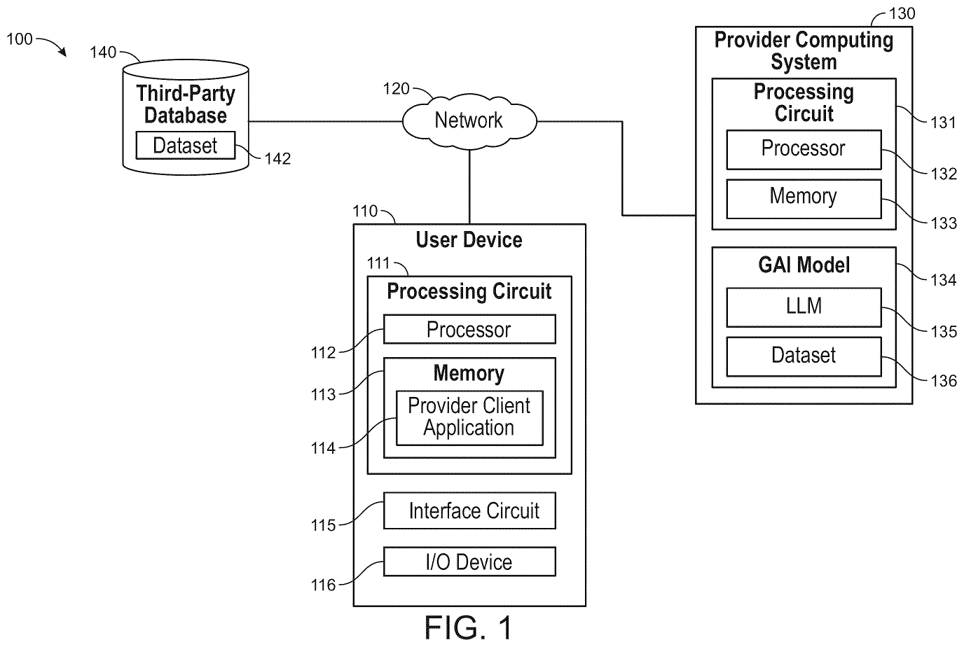

Referring now to FIG. 1, a block diagram depicting an example of a computing environment 100 for analyzing complex graphical data is shown, according to some arrangements. As shown, the environment 100 includes a user device 110, a network 120, a provider computing system 130, and a third-party database 140 coupled and particularly communicably coupled via a network 120. Although the various computing elements of FIG. 1 may be described in the singular form (e.g., user device 110, etc.), it should be understood that the computing environment 100 may include two or more of any device/system described herein (e.g., two or more user device(s) 110, etc.). In various arrangements, components of the environment 100 communicate over network 120. The network 120 may include computer networks such as the Internet, local, wide, metro or other area networks, intranets, satellite networks, other computer networks such as voice or data mobile phone communication networks, combinations thereof, or any other type of electronic communications network. In some examples, network 120 facilitates secure communication between components of computing environment 100. As a non-limiting example, network 120 may implement transport layer security (TLS), secure sockets layer (SSL), hypertext transfer protocol secure (HTTPS), and/or any other secure communication protocol (e.g., using an OSI layer-4 transport protocol such as the User Datagram Protocol (UDP), the Transmission Control Protocol (TCP), Stream Control Transmission Protocol (SCTP), etc.). An illustrative network 120 is the Internet, however, other networks may be used. In some examples, network 120 may be an autonomous system (AS), i.e., a network that is operated under a consistent unified routing policy (or at least appears to from outside the AS network) and may be managed by a single administrative entity (e.g., a system operator, administrator, or administrative group).

In some arrangements, the user device 110 may be a computing device, personal computer (PC), desktop computer, laptop computer, smartphone, tablet, smart watch, smart sensor, or any other device configured to facilitate receiving, displaying, and interacting with content (e.g., applications, etc.) or data that is used by a user, which may be a customer and/or employee associated with the provider institution of the provider computing system 130. For example, user device 110 may be a desktop computer or mobile device configured to execute one or more applications (e.g., provider client application 114) for analyzing or interpreting complex graphical data. The user device 110 may be configured to communicate with one or more elements of the computing environment 100. Further, the user device 110 may be configured to interpret, output, or otherwise process complex graphs and corresponding data, as further described herein. The user device 110 is shown to include at least one processing circuit 111, which may include at least one processor 112 and at least one memory 113. The memory 113 may include or store a provider client application 114. Further, the user device 110 may include an interface circuit 115 and an input/output (I/O) device 116.

The at least one processing circuit 111 may be configured to execute instructions stored in memory 113 to perform one or more of the operations described herein. The processing circuit 111 may include processor 112, which may include a microprocessor, an application specific integrated circuit (ASIC), a field-programmable gate array (FPGA), etc., or combinations thereof. The processing circuit 111 may include memory 113, and the memory 113 may include, but is not limited to, any type of non-transitory computer-readable media (CRM), or any electronic, optical, magnetic, or any other storage or transmission device capable of providing processor(s) with program instructions. The instructions may include code from any suitable computer programming language such as, but not limited to, ActionScript®, C, C++, C#, HTML, Java®, JavaScript®, Perl®, Python®, Visual Basic®, and XML. In some arrangements, the provider client application 114 may be stored and/or executed within the memory 113.

In some arrangements, the user device 110 may include provider client application 114. The provider client application 114 may be a software application configured to interpret, output, or otherwise process complex graphs and corresponding data, as further described herein. The client application 114 may be stored in the memory 113. In some examples, provider client application 114 may include a collection of software development tools in a package (e.g., software development kit (SDK), application programming interface (API), integrated development environment (IDE), debugger, etc.). For example, the provider client application 114 may include an application programming interface (API) or a debugger, or an SDK that includes an API, a debugger, an IDE, and so on. In some implementations, provider client application 114 includes one or more libraries having functions that interface with a particular system software (e.g., iOS, Android, Linux, etc.). As a further example, provider client application 114 may include a function configured to collect, analyze, or output data (e.g., complex graphs), and a user may insert the function into the instructions of provider client application 114 to cause the function to be called during specific actions of provider client application 114.

In some arrangements, the provider client application 114 may be installed and designed to run on desktop computer, smartphones, tablets, and other computing systems and mobile devices. The provider client application 114 may include a client-side application that interacts with server-side components over the network. The provider client application 114 may be implemented using various programming languages and frameworks, such as Swift or Objective-C for iOS, and Kotlin or Java for Android. The provider client application 114 may be packaged and distributed through app stores. In other embodiments, the provider client application 114 is hardcoded into the user device 110. In some implementations, the provider client application 114 may include a presentation layer (UI/UX), a business logic layer, and a data layer. The presentation layer may handle user interactions and displays data using graphical user interface components. The business logic layer may process user inputs, manages application workflows, and enforces rules and policies. The data layer may manage data storage, retrieval, and synchronization with remote servers.

In some arrangements, the provider client application 114 may utilize device capabilities such as cameras, GPS, accelerometers, and touchscreens. The provider client application 114 may operate in online or offline modes, utilizing local storage and caching mechanisms to facilitate functionality when network connectivity is limited. Security measures, such as encryption, authentication, and secure communication protocols, may be implemented to protect user data and provide privacy and security.

In the example shown in FIG. 1, the provider client application 114 is provided and at least partly supported by a provider institution associated with the provider computing system 130. Thus, the provider client application 114 may be referred to as a provider application or provider client application.

In some arrangements, the user device 110 may include interface circuit 115. The interface circuit 115 may be one or more processing circuits configured to provide or display one or more interfaces (e.g., graphical user interfaces (GUIs)) for analyzing complex graphical data. For example, the interface circuit 115, based on instructions from the provider client application 114 and/or the provider computing system 130 directly, may generate or output a single GUI including dynamic elements and/or content used for interpreting a data structure (e.g., hairball graph). Moreover, the interface circuit 115 may be configured to process user interactions or user input responsive to instructions received from the provider client application 114 and/or the provider computing system 130, including selecting or manipulating nodes within the graph, and may further dynamically update one or more visual elements (e.g., a graph or other visualization) in response to the user interactions or user input. In some examples, the interface circuit 115 may present or display one or more visual elements and at least one textual element to a user via the provider client application 114. For example, the interface circuit 115 may provide a GUI to a user via the provider client application 114, which may include visual elements (e.g., graphs or other groupings of related nodes) and/or textual elements (e.g., descriptions or summaries of related nodes).

In some arrangements, the user device 110 may include one or more input/output (I/O) devices 116. The I/O device 116 may interface with the interface circuit 115 to perform various functions described herein with respect to the interface circuit 115. The I/O device 116 may include any type of input only, output only, and/or input/output device. A non-exhaustive list of I/O devices 116 may include a keyboard with alphanumeric and/or other keys, a display or touchscreen display, a biometric sensor, a cursor control, such as a mouse, a trackball, or cursor direction keys for receiving user input or selections. The I/O device 116 may be further configured to manage data exchange between components of FIG. 1, and may implement communications protocols to verify secure and successful transmission of requests for data (e.g., graph updates) and reception of responses (e.g., updated visual elements or textual elements).

In some arrangements, the provider computing system 130 may be one or more computing systems configured to analyze complex graphical data and communicate with the user device 110 to improve and enable quick analysis of complex graphical data. In one embodiment, the provider computing system 130 may be owned by, or otherwise associated with, a provider, which is also referred to as a provider institution. The provider institution may be a provider of goods and/or services. In one embodiment and as shown, the provider institution may be a financial institution, such as a commercial or private bank, credit union, investment brokerage, and so on, such that the provider institution provides one or more financial products and/or services (e.g., a checking account, a savings account, mortgage accounts, bill payment functionality, etc.). The provider computing system 130 is shown to include a generative artificial intelligence (GAI) model 134, which may include a large language model (LLM) 135 and a dataset 136. In some arrangements, the provider computing system 130 includes at least one processing circuit 131, which may be configured to execute instructions stored in at least one memory device or memory 133 to perform one or more operations described herein. The processing circuit 131 may include processor 132, which may include a microprocessor, an application specific integrated circuit (ASIC), a field-programmable gate array (FPGA), etc., or combinations thereof. The processing circuit 131 may include memory 133, and the memory 133 may include, but is not limited to, any type of non-transitory computer-readable media (CRM), or any electronic, optical, magnetic, or any other storage or transmission device capable of providing processor(s) with program instructions. The instructions may include code from any suitable computer programming language such as, but not limited to, ActionScript®, C, C++, C#, HTML, Java®, JavaScript®, Perl®, Python®, Visual Basic®, and XML.

The GAI model 134 refers to an artificial intelligence model(s) configured to generate or output data in response to prompts or requests. The GAI model 134 may include an artificial intelligence (AI) model(s) configured to analyze, interpret, or generate outputs based on complex graphical data structures, such as hairball graphs, using natural language processing (NLP) or other techniques. That is, the GAI model 134 may be configured to identify relationships between nodes, generate ontologies to describe data structures, and/or cluster related data points based on learned patterns. Further, the GAI model 134 may be configured to generate visual elements such as graphs and textual elements such as summaries or explanations of complex graphical data for graph interpretation. In addition, the GAI model 134 may be configured to update complex graphs or corresponding data based on newly received data (e.g., via a supplemental input of a user) and/or training (e.g., using a training dataset, an updated training dataset, or additional training data). In some arrangements, the GAI model 134 may be trained using a training dataset (e.g., a dataset associated with the provider).

In some arrangements, the GAI model 134 may include at least one large language model (LLM) 135. The LLM 135 refers to an artificial intelligence model trained on large datasets (e.g., text data) and configured to interpret and generate human-like text responses to user queries or prompts. In one embodiment, the LLM 135 and/or the GAI model 134 may generate visual elements (e.g., the complex graph, subsets or summaries of the graph, word clouds, etc.) using generative AI systems configured to process and output graphics, such as DALL-E. In some examples, the LLM 135 and/or the GAI model 134 may be configured or trained to interpret a complex graph generated by another system. For example, the GAI model 134 may analyze complex graphical data, such as a hairball graph including one or more interconnected nodes, by using LLM 135 to determine an ontology defining relationships between the data represented by the nodes. In other examples, the GAI model 134 and/or LLM 135 may generate or create an ontology based on concepts included in provided materials (e.g., documents including compliance-related data). Further, the GAI model 134 and/or LLM 135 may identify an existing ontology corresponding with an existing dataset that may be stored (e.g., in dataset 136) for later retrieval and usage.

An ontology may refer to a formal representation of the relationships between different concepts or entities within a dataset, defining how data points (e.g., nodes) are interconnected or related to one another. For example, in the context of a compliance dataset, an ontology may define relationships between data points or nodes representing various regulatory requirements. For example, an ontology may connect or link a node representing an anti-money laundering regulation to nodes representing financial institutions or regions where the law is enforced. That is, the information and connections defined by the ontology reveal relationships between data points in a dataset, such as overlapping compliance obligations or shared regulatory frameworks.

In some examples, the LLM 135 and/or the GAI model 134 may be used by a user or data processing system (e.g., another LLM or GAI model) to interpret visual or graphical data (e.g., visual elements) by providing textual elements including contextual descriptions or by generating natural language explanations relating to the complex graphical data. For example, the LLM 135 of the GAI model 134 may be used to generate a textual summary of the relationships between nodes or data points within a hairball graph for a user to more easily comprehend the complex data presented. In another example, the LLM 135 of the GAI model 134 may cluster or group subsets of data included in a complex graph, particularly a hairball graph, based on processing the hairball graph and detecting features in common between one or more included nodes or data points.

In some examples, the GAI model 134 may include dataset 136. The dataset 136 may refer to a collection of structured or unstructured data used as input for the GAI model 134 and/or LLM 135 to analyze and generate outputs. In some arrangements, dataset 136 may include the underlying data or set of data that is used to generate the nodes and connections of the hairball graph. The dataset 136 may include additional data, such as contextual data or metadata, which may be used GAI model 134 to update complex graphs, descriptions, or ontologies. In some arrangements, the dataset 136 may include compliance information (e.g., laws, rules, guidelines, etc. for various environments, such as for jurisdictions or regions, etc.), customer data, financial transaction records, or any other data relevant to a domain in which the provider institution associated with provider computing system 130 operates.

In some arrangements, user device 110 and provider computing system 130 may be communicatively coupled to one or more databases or data sources, such as third-party database 140. The third-party database 140 may be associated with one or more third-parties relative to the provider institution associated with the provider computing system 130. In some arrangements, the third-party database 140 may be a part of a third-party computing system, and structured as a data repository that is configured to store data, such as complex graphical data or information used in processing such data. For example, the third-party database 140 may include data structures for storing information such as, but not limited to, graphical node data, ontology data, cluster groupings, node relationship data, and other data associated with interpreting or processing complex graphs (e.g., hairball graphs). The third-party database 140 may also store external contextual data, such as user profiles, metadata about node interactions, or compliance-related information that the provider institution may utilize when processing the graphical data. In some arrangements, third-party database 140 may include one or more storage mediums. The storage mediums may include, but are not limited to, magnetic storage, optical storage, flash storage, and/or RAM. In some arrangements, the provider computing system 130 may implement or facilitate various APIs to perform database functions (i.e., managing, synchronizing, or linking data stored in third-party database 140). The APIs may include, but are not limited to, SQL, ODBC, JDBC, NoSQL, and/or any other data storage and manipulation API.

In some arrangements, the third-party database 140 may include a dataset 142. The dataset 142 may refer to any data or set of data provided by or associated with external entities relative to the provider institution associated with the provider computing system 130. The dataset 142 may store or include information used by the provider computing system 130 to facilitate interactions with external systems, perform data validation, and/or supplement graphical data processing. For example, dataset 142 may include compliance-related data, industry-specific guidelines, customer profiles, and/or transactional information used in complex graphical processing. In another example, the dataset 142 may provide a supplemental resource to improve analysis performed by the provider computing system 130 without being directly included in the dataset used to generate the complex graph. In some examples, dataset 142 may include data points that assist users or data processing systems in contextualizing relationships between nodes in the graph, such as regulatory information, compliance data, user preferences, or other relevant data.

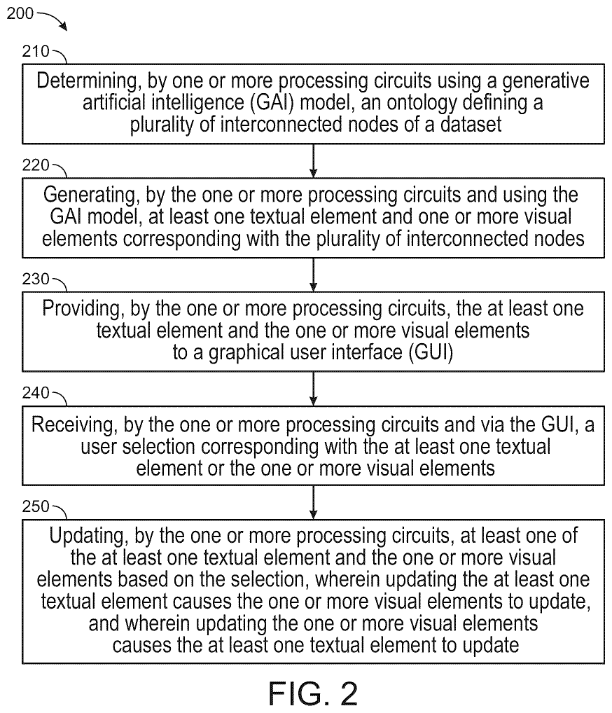

Referring now to FIG. 2, a flowchart for a method 200 for analyzing complex graphical data is shown, according to some arrangements. The method 200 may be executed or implemented by one or more components or systems of FIG. 1 and/or by one or more processing circuits, according to some arrangements. For example, at least user device 110 and/or provider computing system 130 may be configured to perform method 200 or portions thereof. In some arrangements, the steps or blocks of method 200 may be executed sequentially or in parallel (e.g., block 220 and 230 may be performed in parallel). It should be understood that, in other embodiments, the steps of method 200 may be performed in any order, combined, and/or additional modifications implemented, such as the deletion of one or more steps and/or the addition of one or more steps.

In some arrangements, the method 200 includes determining an ontology at block 210. For example, block 210 may include determining, by one or more processing circuits and using a generative artificial intelligence (GAI) model, an ontology defining a plurality of interconnected nodes of a dataset. As described above regarding FIG. 1, an ontology refers to a structure or framework that defines relationships between different data points or elements and/or groupings of data points or elements. An example of an ontology is a framework that connects or links data points representing various regulatory requirements in a compliance dataset, where the relationships between the data points reflect shared categories, such as applicable industries, regions, or compliance obligations. That is, the GAI model 134 of the provider computing system 130 may create or output an ontology defining relationships based on analyzing the dataset 136 and identifying patterns, connections, or relationships between included data points or nodes. For example, the GAI model 134 may store or receive (e.g., from user device 110 or third-party database 140) data corresponding with dataset 136, and may further use natural language processing (NLP) and/or clustering techniques to determine or define relationships between various nodes representing the dataset.

In some arrangements, the GAI model 134 may apply cosine similarity measures or distance-based clustering algorithms to determine ontologies based on grouping nodes with similar attributes, thereby defining relationships based on the proximity of elements within the data structure, as further described herein. When multiple elements are related to each other within a predefined amount (e.g., a distance using cosine similarity as mentioned herein), the elements may be grouped into a category or node by the provider computing system 130. Relationships between the nodes may then be identified by the provider computing system 130 (e.g., the GAI model 134) to develop or form an ontology. For example, a dataset may be specific to anti-money laundering laws, and the GAI model 134 may identify jurisdictions/regions as nodes and relationships defining how the anti-money laundering law of one region relates to that of another region (e.g., via a connection that may be depicted as a line on a hairball graph between two nodes representing two different regions or jurisdictions). In this way, the plurality of interconnected nodes may refer to a set of data points that are visually or logically linked within a graphical structure, such as a hairball graph or a network diagram. Further, connections or interconnections between nodes of complex graphs (e.g., hairball graphs) may represent data used to define ontologies, including relationships, dependencies, or common features. In some examples, the provider computing system 130 may access and/or analyze data for determining an ontology from a third-party data source (e.g., third-party database 140 and/or dataset 142).

In some arrangements, the method 200 includes generating at least one textual element and one or more visual elements at block 220. For example, block 220 may include generating, by one or more processing circuits, at least one textual element and one or more visual elements corresponding with the plurality of interconnected nodes. That is, the user device 110 may generate or provide at least one textual description of the relationships between nodes to a GUI, and may also generate or provide one or more visual elements representing a graphical structure (e.g., hairball graph) of the nodes and connections to the GUI such that a single GUI includes both textual and visual elements for display to a user. In another example, the user device 110 may receive at least one textual element and one or more visual elements generated by the provider computer system 130 and further display the received elements via the GUI provided through provider client application 114. As mentioned above, a textual element may refer to any written or character-based content. The written content may provide explanations, descriptions, and/or summaries of data points and/or relationships between data points of a complex graphical structure (e.g., hairball graph). In some examples, a visual element may refer to a graphical representation of nodes and corresponding interconnections, and/or other images or graphical representations used for complex graphical analysis (e.g., interactive buttons or icons, etc.).

In some examples, the GAI model 134 of the provider computing system 130 may create or output visual elements and textual elements, including summaries and/or textual descriptions within a table, at block 220. For example, the GAI model 134 of the provider computing system 130 may use the LLM 135 to create or output textual descriptions, tabular elements (e.g., tables), and/or labels corresponding with nodes or relationships between nodes. Further, the GAI model 134 and/or LLM 135 may create or output visual elements, such as a hairball graph or portion of a hairball graph including visual representations of data points as nodes and relationships via connections between the nodes, using DALL-E or another visual AI model. In some examples, a user may select a node displayed via the user device 110, and data corresponding to this node (e.g., name, identifier, other linked nodes, etc.) may be inputted as a prompt to the GAI model 134. Additionally, the selected node may be linked to a corresponding textual description and/or to underlying materials (e.g., documentation, notes, etc.), and the textual description and underlying materials may also be provided as input into the GAI model 134 to deliver or output updated written and/or visual content for display via the GUI. In some examples, generating at least one textual element and one or more visual elements at block 220 may include formatting or adjusting a display of the textual element and/or visual element(s) to improve user comprehension or aid in graphical interpretation. For example, the textual element may describe relationships or commonalities between groups of nodes, while the visual element provides an interactive representation of the data such that a user may dynamically interact (e.g., select, highlight, zoom in or out, etc.) with specific nodes, clusters, or relationships associated with the graph to adjust the display of such elements via the GUI and/or to cause updates to corresponding textual or visual elements, as further described herein.

In some arrangements, the method 200 includes providing the at least one textual element and the one or more visual elements at block 230. For example, block 230 may include providing, by one or more processing circuits, the at least one textual element and the one or more visual elements corresponding to the plurality of interconnected nodes for display via the GUI. That is, the user device 110 may display data or content generated at block 220 via a GUI provided by the provider client application 114 and rendered by the interface circuit 115 for display via the I/O device 116. The GUI may be stored by the application 114 such that core elements of the GUI are easily retrieved and provided. The content that populates the GUI of the application may be received by the user device 110 from the provider computing system 130 over the network 120. For example, data corresponding to visual elements and/or textual elements may be transmitted as data packets or otherwise received by the user device 110 via communications facilitated by network 120. In some arrangements, the providing may include the user device 110 organizing or updating the GUI displayed via the provider application 114 by, for example, formatting visual elements as dynamic graphical objects (e.g., interactive node graphs) or providing textual elements organized as dynamic text fields (e.g., interactive labels, descriptions, or tabular data).

In some arrangements, the method 200 includes receiving a selection corresponding with the at least one textual element or the one or more visual elements at block 240. For example, block 240 may include receiving, by one or more processing circuits and via the GUI, a selection corresponding with the at least one textual element or the one or more visual elements. That is, the user device 110 may detect a user interaction or user input, such as a selection of a node or a related textual description, via the I/O device 116. In some examples, receiving the selection may include the user device 110 detecting input from the user via an interactive element within the GUI, such as detecting the user selecting, clicking, or tapping on a visual node within the graph or a corresponding textual element. For example, user device 110 may capture a user selection via input/output (I/O) device 116 and transmit corresponding selection data to the provider computing system 130 for further processing (e.g., to update ontologies, visual elements, textual elements, etc.), and the provider computing system 130 may process the received data using the GAI model 134 and further transmit the processed data (e.g., updated textual and/or visual elements) to the user device 110 for display via the GUI.

In some examples, the selection received at block 240 may correspond to a specific node in the graph or a set of related nodes, another visual element, or a textual element displayed via a GUI of user device 110. In addition, the selection received via user device 110 may trigger an update to the visual displays or the corresponding textual descriptions of the selected visual element or the select textual element and corresponding elements, as further described herein. In some examples, the user device 110 may detect multiple clicks on various elements (e.g., nodes, lines, or other graphical elements) within the graph, enable highlighting of a selection via an area selection tool, or receive and process a verbal instruction to highlight certain nodes, clusters, or areas of interest via the I/O device 116. In other examples, the user device 110 may detect touch inputs, such as dragging, pinching, or zooming gestures, to modify or highlight visual elements, adjust graph views, or select specific textual elements corresponding to nodes. The user device 110 may receive user input from any form of interaction, including keyboard input, stylus gestures, or voice commands, and further update visual and/or textual components displayed via the GUI based on the received user input.

The method 200 may include updating the textual element(s) and/or visual element(s) at block 250. For example, block 250 may include updating, by the one or more processing circuits and via the GUI, at least one of the at least one textual element or the one or more visual elements based on the selection. For example, the selection received via user device 110 may cause the provider client application 114 to instruct the interface circuit 115 to update selected visual elements, selected textual description, and/or corresponding textual descriptions or visual elements. Additionally, the selection may correspond with other functions and/or processes for complex graphical analysis (e.g., zooming, refreshing, etc.), and/or may be used to trigger additional processing by the provider computing system 130. As described herein, the selection may correspond to a subset of linked or related nodes. In some examples, responsive to a selection, the GAI model 134 or LLM 135 may analyze selected data and update the display based on the relationships between selected nodes, clusters, or other visual/textual elements. That is, graphical elements may be displayed on a graphical user interface (GUI) via user device 110 and may be dynamically updated based on user interactions or newly processed data at block 250.

In some arrangements, still referring to block 250, updating the at least one textual element may cause the one or more visual elements to update. For example, a user may select (e.g., by clicking on and/or highlighting) a textual description within the GUI (e.g., a label or summary of node relationships), and the user device 110 and/or provider computing system 130 may modify, update, or re-arrange the corresponding visual elements, such as nodes or clusters within the graph, based on the selected textual description. In some examples, selecting a description of a particular group of related nodes may cause the interface circuit 115 to highlight the corresponding nodes in the graph, which may be used to quickly locate relevant data that would be difficult to otherwise determine. For example, selecting a textual description that summarizes a set of regulatory nodes in a compliance-related dataset may cause the user device 110 to highlight or otherwise indicate nodes associated with specific regulations within the graph displayed to the user. In some arrangements, updating the one or more visual elements causes the at least one textual element to update via the provider client application 114 (if the GUI is displayed within the application) or via the provider computing system 130 (e.g., in embodiments in which the provider computer system 130 provides the GUI). For example, a user may select a node or a group of nodes within the graph presented on the GUI of the user device 110, which may cause the user device 110 to display a new textual element or an update a corresponding textual description, label, or summary related to the selected nodes via the I/O device 116. For example and when the graph is provided by the provider computing system 130, selecting a specific node in a hairball graph may cause the GAI model 134 to update the textual description to summarize attributes, relationships, or contextual details of the selected node(s), such as identifying common features or relationships with other nodes. Beneficially, as described herein, the user device 110 provides a single, dynamic graphical user interface with elements dynamically linked for responsive updates based on user selections that avoids the user navigating through multiple GUIs to reduce computer power consumption.

In some arrangements, the graphical user interface (GUI) includes at least a first textual element, a second textual element, and a visual element. The first textual element may refer to a description field, which is populated with generative AI-generated text (e.g., generated using GAI model 134 and/or LLM 135) in response to one or more selections via user device 110. The second textual element may include an organizational field or table that lists attributes associated with the visual elements on the GUI. The visual element may be a graph, more particularly a hairball graph, visually representing multiple nodes and connections between the nodes. The GUI may dynamically link each of the first textual element, second textual element, and visual element such that analysis of the visual element may be used to provide corresponding comprehensible data in both the first and second textual elements to assist a user in interpreting the graph. The single GUI may update each of the first textual element, second textual element, and/or visual element dynamically update in response to user selections or received data, as further described herein.

In some arrangements, generating the at least one textual element and one or more visual elements corresponding with the plurality of interconnected nodes at block 220 may further include clustering, by the one or more processing circuits, at least two nodes of the plurality of interconnected nodes based on the determined ontology. For example, the GAI model 134 may apply clustering algorithms such as K-means or hierarchical clustering to group related nodes based on identified or extracted attributes (e.g., identifiers) or based on relationships within the dataset 136. In some examples, cosine similarity may be used to identify and cluster nodes with similar features, grouping nodes that share common attributes or relationships and/or visually representing such nodes as a cluster in the GUI. As one example, the GAI model 134 may cluster two or more nodes based on determining each of the nodes is associated with an institution that complies with both GDPR and AML (Anti-Money Laundering) regulations, and the user device 110 may group the clustered nodes visually (e.g., using highlights) in the hairball graph such that users may easily view companies adhering to both GDPR and AML. In another example, the GAI model 134 may cluster two or more nodes representing transactions, where each node is linked to a transaction flagged for exceeding a certain transaction threshold (e.g., $10,000) and triggering a high-risk fraud alert. Additionally, the user device 110 may visually group these clustered nodes in the hairball graph by highlighting the nodes sharing the same risk characteristics to assist users in quickly identifying high-risk financial activities. That is, the user device 110 may provide visual representations or textual elements corresponding with clustered nodes by grouping related nodes together in the hairball graph or including the nodes together in a table with descriptions, making it easier for users to comprehend the relationships between nodes and extract meaningful insights.

In some arrangements, generating the at least one textual element and one or more visual elements corresponding with the plurality of interconnected nodes at block 220 may further include identifying, by the one or more processing circuits using the GAI model, one or more features common to the at least two nodes. For example, the GAI model 134 may cluster or group nodes based on analyzing node attributes (e.g., the identified one or more features, metadata, labels, node relationships, etc.) and/or determining shared characteristics or common features between two or more nodes (e.g., a subset or cluster). Identifying may include the provider computing system 130 processing large datasets and extracting features such as common links, shared categories, or correlated data points. In some examples, identifying may include the provider computer system 130 clustering nodes representing data points based on similarities or commonalities. Further, the provider computer system 130 may track and store data corresponding to grouped or clustered nodes for later use (e.g., refining a determined ontology manually based on user input). In some examples, the GAI model 134 may identify that two or more nodes are linked based on compliance-related attributes or data corresponding to the two or more nodes, based on determining that nodes share common metadata (e.g., tags) indicating association with a particular regulation or standard, or using various additional techniques or parameters.

In some arrangements, generating the at least one textual element and one or more visual elements corresponding with the plurality of interconnected nodes at block 220 may further include modifying, by the one or more processing circuits, the at least one textual element based on the identified one or more common features. For example, after identifying common features between clustered nodes, the user device 110 and/or GAI model 134 may dynamically update or generate textual elements, such as generating new descriptions or modifying existing labels to reflect or present commonalities (e.g., features being common to one or more nodes). For example, if two or more nodes are clustered based on their association with similar anti-money laundering regulations, the GAI model 134 may modify or update textual descriptions corresponding with the nodes and provide the updated description to the user device 110, which may display a shared description reflecting the regulatory alignment of the clustered nodes. For example, two or more nodes may be clustered in a table provided via the GUI, the user device 110 may update the GUI to display a title or label such as “AML compliance required across jurisdictions” in the table. In addition, the user device 110 and/or GAI model 134 may dynamically generate or update visual elements based on clustered or grouped nodes, such as modifying displays of a complex graphs or displaying subsets of nodes of the graphs based on the identified common features. For example, if nodes are clustered based on association with transactions exceeding a certain financial threshold, the GAI model 134 may update the visual depiction of the clustered nodes such that the clustered nodes are highlighted based the common financial criteria of the nodes, or are otherwise visually distinguished from nodes that are not associated with the cluster (e.g., via presentation as a graph including a subset or portion of all nodes included in the hairball graph).

In some arrangements, identifying the one or more features common to the at least two nodes at block 220 further includes extracting, by the one or more processing circuits, one or more indicators corresponding with the at least two nodes. The indicators may refer to data, parameters, or characteristics used to group or define various nodes. For example, the GAI model 134 may extract regulatory compliance indicators, such as compliance tags (e.g., GDPR or AML compliance), which indicate whether a node adheres to a specific legal framework or standard. Additionally, indicators may include other node-specific attributes like relationship data, which define connections between nodes, or data classification levels (e.g., confidential, internal), which categorize nodes based on security level or usage. The provider computing system 130 may use these indicators to detect shared features or relationships between nodes for clustering. Additionally, the indicators may be weighted based on factors such as significance such that the GAI model 134 may prioritize certain features (e.g., compliance status) over others (e.g., geographic location).

In some arrangements, identifying the one or more features common to the at least two nodes further includes determining, by the one or more processing circuits, the one or more features based on inputting the one or more indicators into the GAI model. For example, the extracted indicators may be input into the GAI model 134, which analyzes the data and determines the relevant features shared between nodes using generative artificial intelligence. For example, the GAI model 134 may apply machine learning algorithms (e.g., decision trees, clustering algorithms, or neural networks) to analyze the indicators and output a determination of the common features linking the nodes. In another example, the GAI model may be or may include a large language model (e.g., LLM 135), which may analyze extracted node data or relationship data between nodes to identify that nodes share common features (e.g., both nodes are connected to a particular regulatory framework or share specific transaction attributes). In some examples, by analyzing the extracted indicators, the GAI model 134 may provide a detailed analysis of shared characteristics of nodes and improve the interpretation and processing of complex graphical data.

In some arrangements, determining the ontology at block 210 may further include receiving, by the one or more processing circuits and via the GUI, a supplemental input associated with the dataset. For example, the supplemental input may refer to user-provided information, which may be used by the GAI model 134 in generating the ontology in some embodiments, or in refining or updating the ontology generated by the GAI model 134 in other embodiments. The supplemental input may be provided via the GUI displayed on user device 110 and may include user-provided information, manual clustering preferences, or additional context for interpreting node relationships. For example, user device 110 may receive or process additional information from a user specifying that certain nodes belong to a particular category (e.g., nodes related to specific regulatory requirements), which may be used adjust or refine the ontology generated by the GAI model 134. In another example, the user may define a custom rule linking specific nodes based on domain knowledge not initially detected by the GAI model 134, thereby supplementing the automatically generated relationships within the ontology.

In some arrangements, determining the ontology at block 210 may further include updating, by the one or more processing circuits, the GAI model based on the supplemental input. For example, upon receiving user input, the GAI model 134 may be updated to incorporate the supplemental information into an existing ontology. For example, determining the ontology or updating the GAI model may include modifying the relationships between nodes, redefining node clusters, or adding new connections based on received input. For example, the user may identify a relationship between two previously unlinked nodes, and the GAI model 134 may update the ontology to reflect the newly identified relationship. In some examples, the GAI model 134 may further use the supplemental input to retrain machine learning algorithms or update clustering rules, improving future analyses of similar datasets and providing more refined models, which generate more contextually accurate ontologies for complex graphical data over time.

In some arrangements, responsive to receiving additional data via the GUI, the method 200 may further include updating, by the one or more processing circuits, at least one of the ontology or the depicted graphical depiction plurality of interconnected nodes. In operation, additional data may be sourced or retrieved from third-party data sources (e.g., third-party database 140) in some embodiments, or may be user-provided via supplemental inputs received through the user device 110 in other embodiments (e.g., as described above). In some examples, updating may include the provider computing system 130 accessing new or additional data from external sources (e.g., compliance databases, customer profile datasets stored in dataset 142 of third-party database 140) that affect the relationships or clustering of nodes within a determined ontology, and the additional data may trigger updates to the generated ontology or modifications to node relationships in response to external changes (e.g., updated regulations, new customer data, etc.). In other examples, the provider computing system 130 may receive additional data from user-defined parameters or settings, and the user device 110 and/or GAI model 134 may update the ontology and adjust the structure of interconnected nodes in real-time based on the received data. For instance, if new data from a third-party data source indicates a compliance status change for one or more nodes, the GAI model 134 may update the ontology to reflect the new node relationships or modify the clustering of affected nodes accordingly.

In some arrangements, the method 200 may further include modifying, by the one or more processing circuits, at least one of the at least one textual element or the one or more visual elements based on at least one of the updated ontology or the updated plurality of interconnected nodes. For example, as described above, after updating the ontology or node relationships, the GAI model 134 may automatically update corresponding textual descriptions and/or visual elements displayed on the GUI. In some examples, the textual descriptions of the nodes may be modified to reflect updated relationships or features based on newly received data. Further, if the ontology has been updated to reflect new clustering or changes in node connections, the visual elements (e.g., graphs or node maps) presented on user device 110 may also be updated dynamically. For example, the user device 110 may display an updated graph highlighting new connections between nodes or reflecting changes in node clustering based on the updated ontology. This dynamic interaction between updated ontologies and visual/textual elements further improves the interpretation of complex data structures by providing up-to-date insights based on new information received from third-party sources or user inputs.

In some arrangements, the at least one textual element includes a description of one or more of the plurality of interconnected nodes. For example, the textual element may include a summary or label related to individual nodes or groups of nodes within the graph, providing information such as metadata, relationships, or attributes associated with each node. In some examples, the descriptions may include compliance details, customer profiles, or transaction-specific data linked to each node. The GAI model 134 may dynamically generate or update the descriptions based on the determined ontology or new data received during method 200. In some arrangements, at least one of the one or more visual elements includes a graph with one or more of the interconnected nodes. For example, the visual element may display a hairball graph or network diagram representing nodes, links, or clusters based on relationships identified by the GAI model 134. The visual elements may be interactive such that users may select, zoom, or manipulate the nodes for further analysis or to reveal additional textual information. Additionally, the graph displayed via user device 110 may highlight specific connections or clusters and be configured to adjust dynamically in response to user interactions or updates to the ontology.

In some arrangements, the method 200 further includes generating, by the one or more processing circuits, the graph based on the ontology. In some arrangements, the graph may be provided in the GUI executing on provider client application 114 of user device 110. For example, the GAI model 134 may generate the graph and provide the graph to the user device 110 for output based on determining or identifying an ontology associated with a dataset used to form the graph. In one embodiment, the graph is a hairball graph such that GAI model 134 produces a visual representation of interconnected nodes in the hairball graph. In some embodiments, the generation of the graph may include rendering the graph using a generative model (e.g., DALL-E or another GAI model) that is displayed via the GUI. In other embodiments, the GAI model 134 may update existing portions of the graph. In some arrangements, the method 200 further includes updating, by the one or more processing circuits, one or more of the plurality of interconnected nodes of the graph in the GUI responsive to the selection. For example, if the user selects a particular node or cluster within the graph, the GAI model 134 may update the corresponding visual elements to reflect new relationships or additional connections. In some examples, updating visual elements or textual elements may include the user device 110 or provider computing system 130 adjusting node positions, updating visual or textual labels, re-clustering or regrouping nodes, or otherwise modifying node connections in the displayed graph.

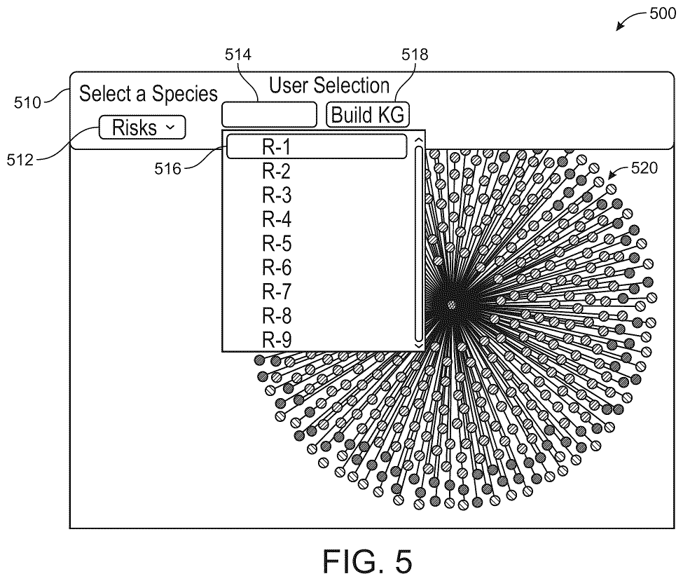

In some arrangements, the method 200 may further include, in generating the graph, generating, by the one or more processing circuits, the graph based on a predefined query associated with one or more of the plurality of interconnected nodes. For example, the GAI model 134 may receive a predefined query including identifiers or attributes associated with one or more data points in a dataset (e.g., data associated with compliance status, regulatory data, relationships, etc.) and generate an output based on prompting the LLM 135 using the predefined query In some examples, the output may include a graph, and particularly a hairball graph, generated by the provider computing system 130 using the predefined query as input. For example, the GAI model 134 may analyze the dataset 136 in conjunction with data provided via the predefined query to construct a graph that reflects the nodes and relationships that meet query criteria. The user device 110 may display user-interactive elements via the GUI for the user to select a predefined query (e.g., from a list including multiple queries), as shown in FIG. 5. Accordingly, the user device 110 may provide an initial or query-specific graph useful for focusing on data subsets (e.g., regulatory-compliant nodes, nodes linked to specific transactions, etc.) and facilitating efficient analysis of a dataset used to generate the graph (e.g., dataset 136) based on predefined conditions.

In some arrangements, the predefined query corresponds with at least one parameter associated with an initial depiction of a portion of the plurality of interconnected nodes. For example, the predefined query may include identifiers or attributes such as compliance data, regulatory data, relationships, and the GAI model 134 may generate an initial depiction of the graph including a subset of nodes based on the inputted identifiers and/or attributes. For example, the user device 110 may provide the initial depiction via a graphical user interface and may dynamically update or refine the initial depiction based on further interactions or additional data, such as receiving a user selection of a node or detecting a change in query conditions. For example, the GAI model 134 may adjust the graph layout or visual representation as the dataset 136 is updated or as the user inputs new query parameters. In some examples, the predefined query may be used by provider computing system 130 to quickly and efficiently generate targeted visual representations in response to evolving conditions. The predefined query may further reduce processing times or system resource load on the provider computing system 130 by providing a refined or streamlined initial dataset or ontology for generating a data representation (e.g., hairball graph) that may be further refined and updated over time or in response to updated data or conditions.

In some arrangements, the one or more visual elements visually depict at least a subset of the plurality of interconnected nodes. That is, visual elements (e.g., a portion of a graph, network diagram, or other visual element) may be distinct or partially distinct from textual elements (e.g., providing descriptive information such as summaries, labels, or other data related to the graphical nodes or connections). For example, visual elements may show nodes as points or circles with corresponding connections as lines or edges, visually representing the relationships between the nodes, while the textual elements may provide supporting context or further explanation using textual descriptions (e.g., words). In some examples, textual elements and visual elements may be displayed simultaneously on a GUI and further updated based in interactions with other textual or visual elements.

In some arrangements, the plurality of interconnected nodes may form a hairball graph, which may refer to a complex, densely interconnected graph structure where numerous nodes and links overlap. Hairball graphs and other complex data structures may visually represent intricate relationships between data points that may not be easily understood through simple visual structures, but may still be difficult to interpret or process due to the number of nodes and corresponding connections. In other embodiments, other types of graphical representations or data structure, such as hierarchical tree diagrams, radial layouts, or force-directed graphs, may be interpreted by provider computing system 130 and presented via user device 110. In some examples, different graph types may provide users with visualizations of different aspects of a single dataset (e.g., dataset 136) and provide multiple ways to explore and interpret the data, or may be used with additional datasets or multiple datasets. For example, the user device 110 may provide a radial layout to highlight central nodes and direct relationships or implement a force-directed graph to visually separate clusters of nodes based on shared or common features.

In some arrangements, as described above, the GAI model 134 includes a large language model (LLM) 135. However, other types of machine learning models, such as clustering algorithms, decision trees, or neural networks, may also be used (e.g., depending on a type of analysis used for generating and interpreting the graphical data structures, based on the underlying dataset, etc.). In some arrangements, each GAI model may be trained to identify patterns, generate descriptions, and refine the relationships between nodes within the dataset 136.

In some arrangements, the method 200 may further include training, by the one or more processing circuits, the LLM using a training dataset. For example, the LLM 135 may be trained using domain-specific data, which may be sourced from dataset 142 in third-party database 140, such as regulatory guidelines, compliance records, or customer-specific data. In some arrangements, training the LLM 135 using the training dataset may improve the capability of the LLM 135 to accurately or efficiently analyze and generate outputs based on dataset 136. As the LLM 135 processes training data or training datasets, the LLM may refine stored data used for ontology generation, update nodes, or generate more precise visualizations, descriptions, or summaries aligned with specific domain parameters. That is, the LLM 135 may be iteratively trained, which results in the generation of an improved GAI model trained to contextually interpreting complex graphical data or a specific set of such data. For example, training may improve the capacity of the GAI model to produce increasingly accurate, domain-specific outputs corresponding to the complex graphical data.

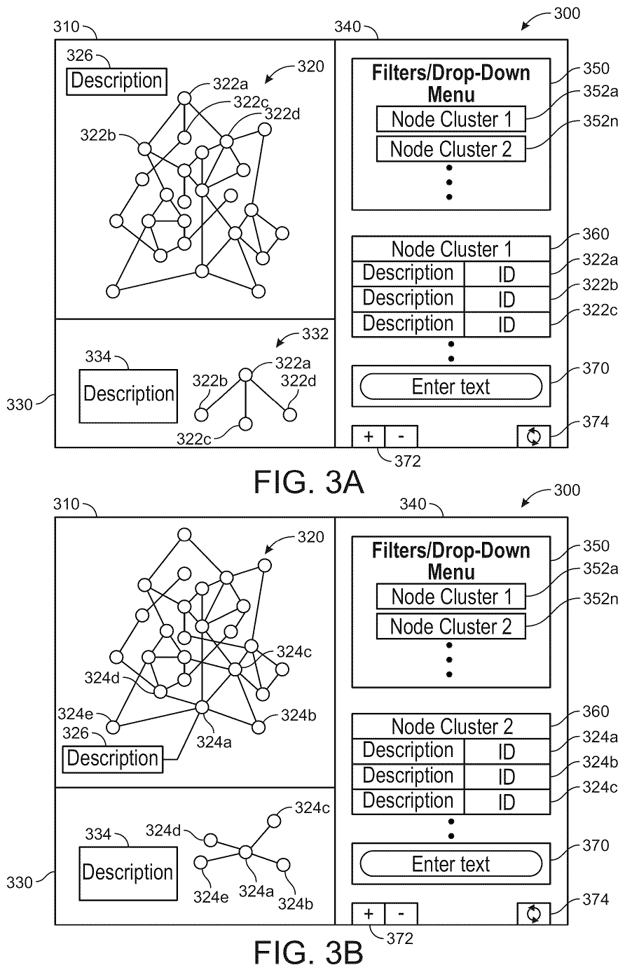

Referring now to FIGS. 3A-3B, an illustrative graphical user interface (GUI) 300 is shown, according to some arrangements. As shown in FIGS. 3A-3B, the GUI 300 may be a dynamic graphical user interface or dynamic GUI configured to update between one or more states. For example, FIG. 3A may depict an initial state of GUI 300, and FIG. 3B may depict an updated state of GUI 300. In some arrangements, the GUI 300 is provided by user device 110 via provider client application 114. In other arrangements, the GUI 300 is provided as a hosted website and is accessible by the user device 110 via network 120. In some arrangements, the GUI 300 is configured to display, analyze, and process complex graphical data structures, such as a hairball graph, by integrating multiple visual elements (e.g., graphs, node maps) and textual elements (e.g., node descriptions, summaries) into a unified display and dynamically updating the textual and/or visual elements based on user input or receiving updated data. It should be understood that the GUI 300 may include additional, fewer, or alternative visual or textual elements in various embodiments.

Referring now to FIG. 3A, the GUI 300 may include a first portion 310 and a second portion 340. The first portion 310 may include a graph 320 and a subset view 330. The graph 320 may include one or more interconnected nodes 322a-322e (collectively, interconnected nodes 322) and a description 326. The subset view 330 may include a subset graph 332 and a description 334. Further, the second portion 340 may include a drop-down menu 350, a table 360, user input element 370, and additional controls 372 and 374. The drop-down menu 350 may include one or more node clusters 352a-352n (collectively, node clusters 352). The table 360 may include entries corresponding with interconnected nodes 322.

In some arrangements, the first portion 310 is configured to display the graph 320 and corresponding additional visual or textual elements for analyzing the relationships between nodes of graph 320. In some arrangements, the second portion 340 provides controls or other elements including mechanisms for filtering, selecting, and interpreting portions of data displayed in the first portion 310 of the GUI 300. For example, the first portion 310 of GUI 300 may display graph 320, which shows a plurality of interconnected nodes 322 corresponding to data points in a dataset (e.g., dataset 136). The interconnected nodes 322 may be linked or displayed as including links or connects based on relationships or ontologies related to the underlying dataset determined by the GAI model 134. For example, nodes 322 may share a common attribute such as regulatory compliance, and the links between the nodes 322 may represent shared characteristics or dependencies (e.g., features in common between one or more. Further, the description 326 may include a textual element providing a textual summary or explanation of interconnected nodes 322, which may be dynamically updated as the user interacts with elements of the first portion 310 or the second portion 340.

In some arrangements, the GUI 300 may include a subset view 330, which may include the subset graph 332. The subset graph 332 may include and display the interconnected nodes 322 in detail or isolation (e.g., removing unrelated nodes from the display of subset graph 332). That is, the subset graph 332 may provide a summary or focused view of selected nodes and provide users with a data visualization to assist in analyzing specific clusters or determining relationship between sets of nodes. In some examples, the description 334 may include a summary or other textual element that summarizes the relationships or common features of the nodes displayed in the subset graph 332. Further, the subset view 330 and included textual elements (e.g., summary description 334) or visual elements (e.g., subset graph 332) may be dynamically updated based on user selections or interactions with the GUI 300 or other received data.

In some arrangements, the GUI 300 may include drop-down menu 350, which may include node clusters 352a-352n. In some examples, node clusters 352 may refer to groups of related nodes that have been clustered or categorized by the GUI 300 using the GAI model 134 based on shared attributes, types, categories, or other parameters. For example, node cluster 352a may represent a group of nodes that share a compliance tag, while node cluster 352n may represent a group of nodes related to a specific transaction type. The drop-down menu 350 may filter the node clusters displayed in the graph 320 to include specific node clusters and assist users or data process systems in focusing analysis on relevant data subsets without navigating through the entire graph 320.

In some arrangements, table 360 provides a structured view of the data corresponding to one or more nodes. For example, as shown on FIG. 3A, data corresponding to the set of the interconnected nodes 322 (e.g., node cluster 1) may be displayed in graph 320. In some examples, the table 360 may include one or more rows or columns with entries, and each entry in table 360 may correspond to a node or group of nodes and may include details such as node descriptions, node IDs, or metadata associated with the nodes. For example, the table 360 may include entries corresponding with one or more interconnected nodes 322a, 322b, and 322c and include an identifier and description for each node. In some examples, the table 360 may be scrollable, such that the user may review information corresponding to one or more nodes in a cluster and further scroll to access information corresponding to additional nodes (e.g., to access or view an entry for interconnected node 322d). Additionally, the GUI 300 may dynamically update table 360 based on various user interactions or inputs via GUI 300 or based on received data (e.g., supplemental or contextual inputs).

In some arrangements, the user input element 370 may be configured to receive supplemental data or user input, which may be transmitted to the GAI model 134 to update the ontology or modify node relationships. For example, a user may input contextual information, such as identifying relationships between nodes not initially detected by the GAI model 134, or providing additional data that may influence how nodes are clustered or linked, via the GUI 300. The GUI 300 may provide the input to the GAI model 134 and may further adjust the relationships within graph 320, update textual descriptions corresponding to the nodes displayed, or otherwise update textual or visual elements of the GUI 300. In some examples, the user input element 370 may include various interactive components, such as text fields, buttons, or other GUI-based inputs such that users may submit data or queries associated with the graph 320 using the user input element 370. For example, a user may select a node cluster from drop-down menu 350 and provide additional context through a text field, which may cause the GUI 300 to update graph 320 or table 360 to reflect the new data or relationships or updated ontologies. Additionally, data received by the GUI 300 via the user input element 370 may be provided to the user device 110 and/or provider computing system 130.

In some arrangements, the GUI may include various additional controls 372 and 374 to assist in analyzing complex graphical data or to improve user interaction with the GUI 300. For example, users may select additional controls 372 to zoom in on interconnected nodes 322 within graph 320 for closer inspection of associated node connections and relationships. In another example, additional controls 374 may include a refresh or update function that updates one or more elements within GUI 300 to verify that the visual and textual elements (e.g., table 360, graph 320, description 326) are synchronized with a recent dataset or updated user input. In some examples, the GUI 300 may include various controls (not pictured) for users to filter the data displayed, adjust the layout of the graph, toggle between different views of graph 320 and corresponding textual elements, or otherwise interact with the GUI 300 and included data.

Referring now to FIG. 3B, the GUI 300 is shown in an updated state based on user interaction, changes to visual or textual elements, and/or received data according to an example embodiment. In some arrangements, the GUI 300 may be updated based on a user selecting any visual element or textual element, including interacting with graph 320 and/or interconnected nodes 322, description 326, subset graph 332, description 334, drop down menu 350, table 360, and so on. In some embodiments, the GUI 300 may be updated automatically based on receiving data from external sources (e.g., third-party database 140) or supplemental user inputs provided via the user input element 370. FIG. 3B may illustrate the dynamic nature of GUI 300 and shows that updates (e.g., selections of visual elements, selections of textual elements, or other internal or external updates) to elements of GUI 300 may cause the modification to various visual or textual elements displayed via GUI 300.

As shown in FIG. 3B, the GUI may be configured to update one or more textual or visual elements included in first portion 310 of GUI 300 to reflect user input or a received selection. For example, a user may select node cluster 352n (e.g., node cluster 2) corresponding with interconnected nodes 324 from the drop-down menu 350, causing the GUI 300 to update the graph 320 to display or highlight the selected interconnected nodes 324 via the graph 320. As described above regarding the interconnected nodes 322, the interconnected nodes 324 may represent a portion or subset of nodes within the dataset 136 linked by common attributes (e.g., compliance tags or transactional data). In another example, the GUI 300 may receive a selection corresponding with one or more interconnected nodes 324 via graph 320 and further update the graph 320 (e.g., by highlighting or emphasizing certain elements or nodes). Similarly, the GUI 300 may update subset view 330 in response to updates to other visual or textual elements, user selections, and/or the receipt of updated data. For example, the subset graph 332 may be updated to include interconnected nodes 324, which may cause the description 334 to be updated.

In response to updates in graph 320, the description 326 of the first portion 310 may also dynamically update to reflect selected or updated nodes and/or ontologies. For example, the description 326 may provide a textual summary or explanation of the relationships between the selected interconnected nodes 324, including common attributes or shared features (e.g., compliance status, transaction types, etc.), or any other data or textual information. In some arrangements, the description 326 may be updated in response to visual elements being updated (e.g., selecting nodes in graph 320) or based on receiving new data. Further, updates to the description 326 may also trigger changes to visual elements, such as causing the GUI 300 to highlight interconnected nodes 324 via graph 320. For example, a user may highlight a word or phrase within description 326, and the GUI 300 may modify or update graph 320 to display nodes corresponding with the highlighted word or phrase.

Similarly, in some arrangements, various visual or textual elements included within the second portion 340 of GUI 300 may be updated in response to user selections or data inputs. For example, selecting node cluster 352n from the drop-down menu 350 may update both the graph 320 in the first portion 310 and corresponding data entries in table 360. In another example, in response to the user providing input via the user input element 370, the table 360 may update to display data such as descriptions, IDs, or metadata corresponding with one or more of interconnected nodes 324a, 324b, 324c, 324d, and/or 324e. In some examples, the drop-down menu 350 and table 360 may be scrollable, as described above, such that users may navigate through different nodes or node clusters to view additional information corresponding to the selected nodes or additional nodes. Furthermore, additional data received via the GUI 300 may prompt further updates to the visual and textual elements, such as adding new relationships between nodes or updating the clustering rules used by the GAI model 134.

In some embodiments, the GUI 300 may update or otherwise adjust responsive to user input via the additional controls 372 and 374, which may provide users with additional functionality, such as zooming in on nodes within graph 320 or refreshing the entire GUI 300 to synchronize visual and textual elements with the latest data. For example, the GUI 300 may receive user input via the additional controls 372 to zoom in on specific nodes within graph 320 (e.g., to inspect relationships), and the GUI 300 may further receive user input via the additional controls 374 to refresh the entire display of GUI 300 and align the visual and textual elements within GUI 300 with the updated data or datasets, or user selections. Further, in some arrangements, the GUI 300 may include a variety of additional controls not pictured in FIGS. 3A-3B, such as various interactive options to filter data, adjust the graph layout, or toggle between different views of the graph and corresponding textual elements.

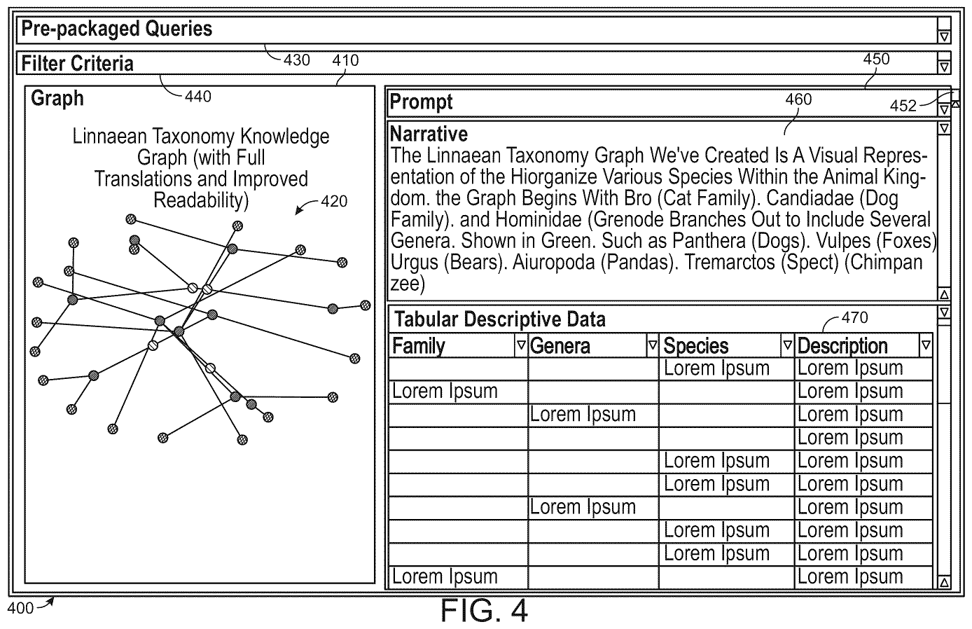

Referring now to FIG. 4, an illustrative graphical user interface (GUI) 400 is shown, according to some embodiments. In some arrangements, the GUI 400 may be provided via a user device 110 (described in FIG. 1) or accessible through a hosted website. In some arrangements, the GUI 400 is provided by user device 110 via provider client application 114. In other arrangements, the GUI 400 is provided as a hosted website and is accessible by the user device 110 via network 120. In some arrangements, the GUI 400 is configured to display, analyze, and process complex graphical data structures, such as a hairball graph, by integrating multiple visual elements (e.g., graphs, node maps) and textual elements (e.g., node descriptions, summaries) into a unified display and dynamically updating the textual and/or visual elements based on received user input or updated data. It should be understood that the GUI 400 may include additional, fewer, or alternative visual or textual elements in various embodiments. As shown in FIG. 4, the GUI 400 may include a display area 410 with a graph 420, a pre-packaged queries section 430, a filter criteria section 440, a prompt element 450 with a voice input element 452, a narrative 460 (e.g., description), and table 470. In some examples, GUI 400 may provide visual representations and textual information associated with relationships between interconnected nodes and may dynamically update various elements based on user input or received data.

In some arrangements, the display area 410 of GUI 400 may display a knowledge graph (e.g., graph 420), which visually represents interconnected nodes and relationships between various elements in a dataset (e.g., dataset 136). In some embodiments, the graph 420 is generated based on selections made via the pre-packaged queries section 430, as described regarding the pre-packaged queries described with regard to FIG. 2. For example, a user may select a pre-configured query from the pre-packaged queries section 430 related to animal taxonomy data, causing the GUI 400 to generate and display the corresponding graph 420, which visualizes the relationships between nodes (e.g., representing species within the animal kingdom) based on the selected query. In some arrangements, the GUI 400 may receive user input via the filter criteria section 440, which may cause the GUI 400 to filter and customize the display area 410, the graph 420, the narrative 460, the table 470, and/or any other visual or textual element based on the received input. For example, a selection of one node of the graph 420 may cause the GUI 400 to highlight associated nodes on the graph 420, update the narrative 460, and/or update the table 470. Similarly, a selection of text within the narrative 460 or entries of the table 470 may cause the GUI 400 to update one or more of the graph 420, the narrative 460, and/or the table 470.

In some arrangements, the GUI 400 includes a narrative 460, which may provide textual descriptions or explanations associated with the nodes and relationships displayed in the graph 420. For example, as shown in FIG. 4, the narrative 460 provides a description or other content related to the visual representation of the graph 420 (e.g., defining or explaining relationships between species or groups, such as Hominidae, Panthera, etc.). In some examples, the narrative 460 may be updated dynamically as the user interacts with the GUI 400, such as when filtering data, selecting specific nodes, or modifying query parameters. In some arrangements, the textual descriptions in the narrative 460 may provide context or additional information that complements the visual elements displayed in the graph 420.

In some arrangements, the GUI 400 include table 470, which provides a structured view of data corresponding to the nodes displayed in the graph 420. For example, the table 470 may include entries for one or more nodes in the graph 420, including data such as node labels, descriptions, metadata, or other attributes relevant to the relationships depicted in the graph 420 (e.g., family, genera, species, descriptions, etc.). In some arrangements, the table 470 may be scrollable such that a user may interact with the table 470 to reveal hidden data or entries.

In some embodiments, the GUI 400 is configured provide dynamic interaction between visual elements (e.g., graph 420) and textual elements (e.g., narrative 460, table 470, etc.). For example, a user may select a node within the graph 420, which may prompt the GUI 400 to update corresponding descriptions in the narrative 460 and/or entries of fields of the table 470. Similarly, adjusting the filter criteria section 440 may trigger updates to the display area 410, graph 420, the narrative 460, and/or the table 470. Additionally, user selections in the narrative 460 (e.g., selecting specific words or phrases) may cause the graph 420 and/or the narrative 460 to update (e.g., highlighting corresponding nodes or relationships within the graph, otherwise adjusting textual or visual elements for interpretation of and/or interaction with the displayed data).

Referring now to FIG. 5, an illustrative graphical user interface (GUI) 500 is shown, according to some arrangements. In some arrangements, the GUI 500 may be provided via a user device 110 (described in FIG. 1) or accessible through a hosted website. In some arrangements, the GUI 500 is provided by user device 110 via provider client application 114. In other arrangements, the GUI 500 is provided as a hosted website and is accessible by the user device 110 via network 120. In some arrangements, the GUI 500 is configured to display, analyze, and process complex graphical data structures, such as a hairball graph, by integrating multiple visual elements (e.g., graphs, node maps) and textual elements (e.g., node descriptions, summaries) into a unified display and dynamically updating the textual and/or visual elements based on received user input or updated data. It should be understood that the GUI 500 may include additional, fewer, or alternative visual or textual elements in various embodiments. As shown in FIG. 5, the GUI 500 may include a selection area 510, a drop-down menu 512, a user input element 514, a drop-down menu 516, a build element 518, and a graph 520. Additionally, GUI 500 may provide visual representations and textual information associated with relationships between interconnected nodes and may dynamically update various elements based on user input or received data.

In some arrangements, the GUI 500 includes selection area 510. In some arrangements, the selection area 510 provides an option to filter or categorize data shown in the graph 520. For example, in some embodiments, the selection area 510 includes a selectable category labeled “Risks,” shown as drop-down menu 512. Further, the GUI 500 may receive user input via the drop-down menu 512, and the GUI 500 may update to filter the data visualized in the graph 520 based on factors associated with the selection via drop down menu 512.

In some arrangements, the GUI 500 includes user input element 514. In some embodiments, the user input element 514 may receive input including specific values (e.g., inputted by a user), search for relevant data points, or select custom data points to tailor or build a knowledge graph, shown as build element 518. For example, a user may search for specific categories, keywords, or identifiers in the input field provided by the user input element 514. The GUI 500 may then update the displayed options or graph 520 based on the input, helping users identify relevant clusters or categories from dropdown menus, such as dropdown menu 516, or facilitating further filtering of data visualized in the graph 520.

In some arrangements, the GUI 500 includes drop down menu 516. In some arrangements, drop down menu 516 presents clustering options dynamically generated by a large language model (LLM) used to organize and structure data within the graph 520. As shown, the dropdown menu 516 includes items labeled R-1 through R-9, which may include cluster options that represent categories or subsets of the overall graph 520. For example, the item R1 may represent a specific category or identifier associated with the graph data. In some arrangements, the identifiers such as R-1 may represent regulatory codes, risk categories, or similar items or data that are difficult to understand in isolation. In some cases, numerical identifiers like R-1 may be replaced with easy-to-understand words or phrases (e.g., “anti-money laundering laws for South Africa”). That is, GUI 500 provides an improved user interface for users to interact with complex datasets even if the users are unfamiliar with specific codes or terms by providing contextual information or descriptions to assist in interpretation of complex graphical data.

In some arrangements, the GUI 500 may include build element 518. The build element 518 may trigger dynamic generation of a knowledge graph (e.g., graph 520) based on selected or inputted clusters or identifiers from the dropdown menu 516. In some arrangements, the graph 520 displays a large number of interconnected nodes and edges. As described above, the arrangement of nodes and connections reflect relationships between different data points or categories clustered by the GUI 500. In some arrangements, the graph 520 may highlight certain nodes or clusters based on user selections made via the dropdown menu 516 or input element 514. Furthermore, the graph 520 may update dynamically as the user selects different clusters or input categories, and the GUI 500 may update the graph based on updated clustering logic, such as cosine similarity measures or techniques.

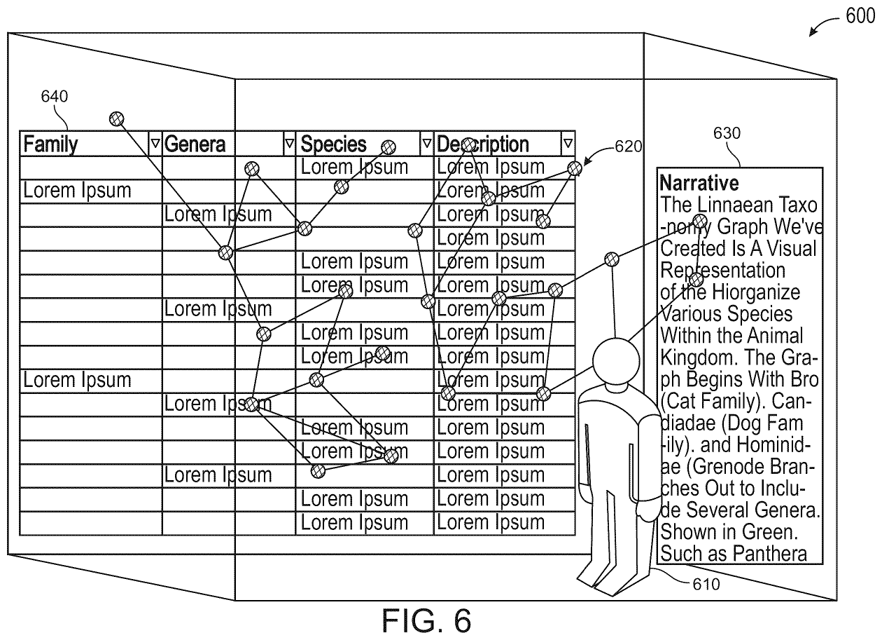

Referring now to FIG. 6, an illustrative three-dimensional space 600 for analyzing complex graphical data is shown, according to some arrangements. As shown in FIG. 6, the three-dimensional space 600 may include a user 610, a graph 620, a narrative 630, and a table 640. In some embodiments, the graph 620 displays various interconnected nodes and relationships in the three-dimensional space 600. Further, in some embodiments, the narrative 630 and/or table 640 provide information related to the graph 620 and/or organize data (e.g., into categories such as “Family,” “Genera,” “Species,” and “Description”) within the three-dimensional space 600. In some embodiments, the user 610 represents a person or individual who may interact with visual elements (e.g., graph 620) and/or textual elements (e.g., narrative 630, table 640, etc.).

In some embodiments, the three-dimensional space 600 includes a virtual reality (VR) system or a holographic projection, which may present one or more GUIs and/or user interface elements (e.g., visual and/or textual) to the user 610 to assist the user 610 in interpreting complex graphical data. In some embodiments, providing a user interface and/or interface elements in the immersive environment provided by three-dimensional space 600 may improve the ability of the user 610 to interact with, explore, and interpret complex data structures by increasing the visibility and ability of the user to interact with the data presented. In some embodiments, the user 610 may rotate, zoom, and navigate through the three-dimensional space 600 and/or interact with various elements using VR controls or hand gestures (e.g., hand waves, etc.), which may cause updates to the visual and/or textual elements included in the three-dimensional space 600. In some embodiments, using a VR system, augmented reality (AR) system, or any holographic system, users may interact with floating elements (e.g., graph 620, narrative 630, and/or table 640) by physically moving or selecting nodes within the graph 620 or items within the narrative 630 or the table 640.

As described above, the graph 620, narrative 630, and table 640 may be three-dimensional elements within the three-dimensional space 600 that may be dynamically updated based on user interaction or received data. For example, in some embodiments, the user 610 selecting a node in the graph 620 may highlight related nodes or update the narrative 630 or the table 640 to display corresponding data. In another example, interacting with the table 640 to filter by a specific category, such as “Genera,” may trigger the graph 620 to adjust and focus on one or more nodes associated with the selection. In another example, as the user 610 explores the graph 620 (e.g., hovers over nodes or clicks on nodes with a mouse or touchscreen element), the narrative 630 may be updated to provide further context or explanation about the selected nodes or clusters.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings. It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor, etc. In some embodiments, the one or more processors may be external to the apparatus, for example the one or more processors may be a remote processor (e.g., a cloud-based processor). Alternatively or additionally, the one or more processors may be internal and/or local to the apparatus. In this regard, a given circuit or components thereof may be disposed locally (e.g., as part of a local server, a local computing system) or remotely (e.g., as part of a remote server such as a cloud-based server). To that end, a “circuit” as described herein may include components that are distributed across one or more locations.

An exemplary system for implementing the overall system or portions of the embodiments might include a general-purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general-purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example embodiments described herein. It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function. Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and embodiment of the embodiments without departing from the scope of the present disclosure as expressed in the appended claims.

What is claimed is:

1. A method, comprising:
determining, by one or more processing circuits using a generative artificial intelligence (GAI) model, an ontology defining a plurality of interconnected nodes of a dataset;
generating, by the one or more processing circuits, at least one textual element and one or more visual elements corresponding with the plurality of interconnected nodes;
providing, by the one or more processing circuits, the at least one textual element and the one or more visual elements to a graphical user interface (GUI);
receiving, by the one or more processing circuits and via the GUI, a selection corresponding with the at least one textual element or the one or more visual elements; and
updating, by the one or more processing circuits and via the GUI, at least one of the at least one textual element or the one or more visual elements based on the selection, wherein updating the at least one textual element causes the one or more visual elements to update, and wherein updating the one or more visual elements causes the at least one textual element to update.

2. The method of claim 1, wherein generating the at least one textual element and the one or more visual elements corresponding with the plurality of interconnected nodes further comprises:
clustering, by the one or more processing circuits, at least two nodes of the plurality of interconnected nodes based on the determined ontology;
identifying, by the one or more processing circuits using the GAI model, one or more features common to the at least two nodes; and
modifying, by the one or more processing circuits, the at least one textual element based on the identified one or more features.

3. The method of claim 2, wherein identifying the one or more features common to the at least two nodes further comprises:
extracting, by the one or more processing circuits, one or more indicators corresponding with the at least two nodes; and
determining, by the one or more processing circuits, the one or more features based on inputting the one or more indicators into the GAI model.

4. The method of claim 1, wherein determining the ontology further comprises:
receiving, by the one or more processing circuits and via the GUI, a supplemental input associated with the dataset; and
updating, by the one or more processing circuits, the GAI model based on the supplemental input.

5. The method of claim 1, further comprising:
responsive to receiving additional data via the GUI, updating, by the one or more processing circuits, at least one of the ontology or the plurality of interconnected nodes; and
modifying, by the one or more processing circuits, at least one of the at least one textual element or the one or more visual elements based on at least one of the updated ontology or the updated plurality of interconnected nodes.

6. The method of claim 1, wherein the at least one textual element comprises a description of one or more of the plurality of interconnected nodes, and wherein at least one of the one or more visual elements comprise a graph comprising one or more of the plurality of interconnected nodes.

7. The method of claim 6, further comprising:
generating, by the one or more processing circuits, the graph based on the ontology, wherein the graph is provided in the GUI; and
updating, by the one or more processing circuits, one or more of the plurality of interconnected nodes of the graph in the GUI responsive to the selection.

8. The method of claim 7, wherein generating the graph further comprises:
generating, by the one or more processing circuits, the graph based on a predefined query associated with one or more of the plurality of interconnected nodes, the predefined query corresponding with at least one parameter associated with an initial depiction of a portion of the plurality of interconnected nodes.

9. The method of claim 1, wherein the one or more visual elements visually depict at least a subset of the plurality of interconnected nodes.

10. The method of claim 1, wherein the plurality of interconnected nodes form a hairball graph, wherein the GAI model comprises a large language model (LLM), and the method further comprises:
training, by the one or more processing circuits, the LLM using a training dataset.

11. A system for interpreting complex data, comprising:
one or more processing circuits comprising one or more processors coupled to one or more memory devices, the one or more processing circuits configured to:
determine, using a generative artificial intelligence (GAI) model, an ontology defining a plurality of interconnected nodes associated with a dataset;
generate at least one textual element and one or more visual elements corresponding with the plurality of interconnected nodes;
provide the at least one textual element and the one or more visual elements to a graphical user interface (GUI);
receive, via the GUI, a selection corresponding with the at least one textual element or the one or more visual elements; and
update, via the GUI, at least one of the at least one textual element or the one or more visual elements based on the selection, wherein updating the at least one textual element causes the one or more visual elements to update, and wherein updating the one or more visual elements causes the at least one textual element to update.

12. The system of claim 11, wherein in generating the at least one textual element and the one or more visual elements corresponding with the plurality of interconnected nodes, the one or more processing circuits are configured to:
cluster at least two nodes of the plurality of interconnected nodes based on the determined ontology;
identify, using the GAI model, one or more features common to the at least two nodes; and
modify the at least one textual element based on the identified one or more features.

13. The system of claim 12, wherein in identifying the one or more features common to the at least two nodes, the one or more processing circuits are configured to:
extract one or more indicators corresponding with the at least two nodes; and
determine the one or more features based on inputting the one or more indicators into the GAI model.

14. The system of claim 11, wherein in determining the ontology, the one or more processing circuits are further configured to:
receive a supplemental input associated with the dataset; and
update the GAI model based on the supplemental input.

15. The system of claim 11, wherein the one or more processing circuits are further configured to:
responsive to receiving additional data via the GUI, update at least one of the ontology or the plurality of interconnected nodes; and
modify at least one of the at least one textual element or the one or more visual elements based on at least one of the updated ontology or the updated plurality of interconnected nodes.

16. The system of claim 11, wherein the at least one textual element comprises a description of one or more of the plurality of interconnected nodes, and wherein at least one of the one or more visual elements comprise a graph comprising one or more of the plurality of interconnected nodes.

17. The system of claim 16, wherein the one or more processing circuits are further configured to:
generate the graph based on the ontology, wherein the graph is provided in the GUI; and
update one or more of the plurality of interconnected nodes of the graph in the GUI responsive to the selection.

18. The system of claim 17, wherein the one or more processing circuits are further configured to:
generate the graph based on a predefined query associated with one or more of the plurality of interconnected nodes, the predefined query corresponding with at least one parameter associated with an initial depiction of a portion of the plurality of interconnected nodes.

19. The system of claim 11, wherein the one or more visual elements visually depict at least a subset of the plurality of interconnected nodes.

20. A non-transitory computer-readable medium (CRM) comprising instructions stored thereon that, when executed by one or more processors, cause the one or more processors to perform operations comprising:
determining, using a generative artificial intelligence (GAI) model, an ontology including a plurality of interconnected nodes of a dataset;
generating at least one textual element and one or more visual elements corresponding with the plurality of interconnected nodes;
providing the at least one textual element and the one or more visual elements to a graphical user interface (GUI);
receiving, via the GUI, a selection corresponding with the at least one textual element or the one or more visual elements; and
updating, via the GUI, at least one of the at least one textual element or the one or more visual elements based on the selection, wherein updating the at least one textual element causes the one or more visual elements to update, and wherein updating the one or more visual elements causes the at least one textual element to update.
